(19) United States
(12) Patent Application Publication
(10) Pub. No.: US 2025/0206998 A1
(43) Pub. Date: Jun. 26, 2025

(54) AN ADHESIVE COMPOSITION FOR A GLASS ARTICLE COMPRISING BLOWING MEANS AND A LAMINATED GLAZING FOR MOTOR VEHICLES COMPRISING SUCH A COMPOSITION

(71) Applicant: SAINT-GOBAIN GLASS FRANCE, COURBEVOIE (FR)

(72) Inventors: Clément RAVET, AUBERVILLIERS (FR); Morgane PETIT, AUBERVILLIERS (FR)

(21) Appl. No.: 18/852,049

(22) PCT Filed: Mar. 28, 2023
(86) PCT No.: PCT/EP2023/057999

§ 371 Date: Sep. 27, 2024

(30) Foreign Application Priority Data
Mar. 30, 2022 (FR) 2202862

(51) Int. Cl. C09J 11/08; B32B 17/10; B32B 43/00; C09J 5/06; C09J 129/14

(52) U.S. Cl. CPC C09J 11/08; B32B 17/10036; B32B 17/1055; B32B 43/006; C09J 5/06; C09J 129/14; B32B 2307/412; B32B 2307/748; B32B 2315/08; B32B 2605/00; C09J 2400/146

(57) ABSTRACT

An adhesive composition for a glass article includes polyvinyl butyral (PVB) and at least one expansion device. There is also provided an automotive laminated glazing including at least two glass sheets, and as lamination interlayer, a layer of such an adhesive composition, and a method for obtaining such a laminated glazing and for disassembling same, including heating the automotive laminated glazing at a temperature between 110° C. and 260° C. for a period of between 0.5 and 10 minutes.

### PRIOR ART

The present invention belongs to the field of disassembly and recycling of glass articles, in particular laminated glass, in particular used in the automotive field.

Today, the recycling of used glass is an issue of prime importance, especially having for stakes the reduction of vitrifiable raw material and the reduction in the environmental footprint of new glass.

A laminated glass consists of glass sheets, bonded together by means of an adhesive composition deposited so as to form an interlayer polymer film, typically based on polyvinyl butyral (PVB).

This type of glass is particularly popular for applications in the automotive field. Indeed, in the event of glass breakage, the polymer film maintains cohesion of the assembly of the glazing and prevents glass shards. This type of glazing is, in this respect, mandatory for windshields of modern vehicles. It is also used for sunroofs or side windows.

However, the difficulty in recycling laminated glass is one of its main disadvantages since it requires the separation of two glass sheets from an adhesive polymer interlayer.

Typically, today, the laminated glass is recycled by means of a grinding operation. However, at the end of that grinding, the recovery materials still contain: 20% by weight of glass in the interlayer polymer (such as PVB) and 5% by weight of interlayer polymer (such as PVB) in the glass.

It is therefore necessary to obtain better separation at the interfaces of the interlayer polymer and of the glass during the recycling of a laminated glass in order to not only improve the quality and the amount of glass recovered but also to allow recycling of the interlayer polymer, reducing the impact thereof on the cost and the durability of a windshield.

### OVERVIEW OF THE INVENTION

The present invention aims to remedy all or some of the disadvantages of the prior art, in particular those disclosed above, by proposing a solution that makes it possible to disassemble the interlayer polymer film formed from an adhesive composition and the glass sheets in a laminated glazing.

To this end, and according to a first aspect, the invention relates to an adhesive composition for a glass article comprising polyvinyl butyral (PVB) and expansion means.

Such a composition according to the invention is of interest, in particular, because it makes it possible, in the context of its application as an interlayer film in a laminated glazing, to weaken the cohesion forces at the interfaces of the PVB and of the glass on demand via the expansion means that it comprises.

In particular, an adhesive composition according to the invention may comprise at least one expansion means selected from microcapsules and/or chemical blowing agents.

The microcapsules used in a composition according to the invention consist of a volatile liquid core and a polymer shell.

The volatile liquid core of the microcapsules is vaporized when it is subjected to heating, which leads to an increase in the volume of the microcapsules and/or to a release of said core in the form of gas in the adhesive composition.

These microcapsules may be said to be “expandable microcapsules” since an increase in their volume is obtained by heating to a temperature greater than or equal to the glass transition temperature of the polymer shell and to the temperature of the vaporization temperature of the volatile liquid core. The increase in volume due to the phase change of the core then creates pressure sufficient to deform the shell.

The increase in volume of the microcapsules and/or the release of gas into the adhesive composition obtained after heating makes it possible to weaken the cohesion forces at the PVB/glass interfaces and thus promotes the separation of two glass sheets for the disassembly of a laminated glazing, in particular for a laminated glazing intended for the automotive industry.

Such microcapsules and thus methods for obtaining them are for example described in applications U.S. Pat. Nos. 3,615,972 A; 4,049,604 A; 4,016,110 A; 4,582,756 A; US 2018/0355216 A1; JP H09/019,635 A; WO 2002/096635 A1; WO 2007/142593 A1 EP 0 486 080 A1; EP 0 572 233 A1; EP 1 149 628 A1; EP 1 964 903 A1 and EP 1 508 604 A1.

The shell of the microcapsules is composed of at least one thermoplastic polymer having a high glass transition temperature, in particular greater than or equal to the vaporization temperature of the liquid core.

Such polymers are capable of being obtained from the polymerization of at least one monomer chosen from (meth)acrylic monomers, aromatic alkenyls, vinyl derivatives, acid monomers and mixtures thereof.

(Meth)acrylic monomers means the monomers of general formula CH₂CH(R′)C(O)OR where R is selected from a C₁-C₁₂ alkyl, a C₃-C₁₀ cycloalkyl, or an aromatic group, optionally substituted with a hydroxy radical or R is a hydrogen atom, and R′ is selected from a hydrogen atom and a methyl.

Among the (meth)acrylic monomers that are suitable for the present invention, mention may be made of methyl methacrylate, ethyl acrylate, propyl acrylate, butyl acrylate, butyl methacrylate, propyl methacrylate, lauryl acrylate, 2-ethylhexyl acrylate, ethyl methacrylate, isobornyl acrylate, isobornyl methacrylate, 2-hydroxyethyl acrylate and 2-hydroxyethyl methacrylate.

“Aromatic alkenyl” refers to the monomers of general formula Ar—CHCH₂ wherein Ar represents an aromatic hydrocarbon radical, optionally substituted with a halogen.

Among the aromatic alkenyls, mention may be made of styrene, ortho-methylstyrene, meta-methylstyrene, para-methylstyrene, ethylstyrene, vinyl xylene, chlorostyrene, bromostyrene and styrene derivatives such as vinylbenzyl chloride and para-tert-butylstyrene.

Among the vinyl derivatives, mention may be made of acrylonitrile, methacrylonitrile, vinyl halides, vinyl esters and vinyl ethers.

Among the vinyl halides, mention may be made of vinyl chloride, vinyl bromide and vinylidene chloride.

“Vinyl ester” refers to compounds of general formula CH₂CHOC(O)R where R is a C₁-C₁₇ alkyl.

Among the vinyl ester monomers, mention may be made of vinyl acetate, vinyl benzoate, vinyl butyrate, vinyl stearate, vinyl laurate, vinyl myristate and vinyl propionate.

Among vinyl ethers, mention may be made of methyl vinyl ether, ethyl vinyl ether, propyl vinyl ether, isopropyl vinyl ether, butyl vinyl ether, isobutyl vinyl ether, tert-butyl vinyl ether, sec-butyl vinyl ether and mixtures thereof.

Among the acid monomers, mention may be made of acrylic acid, methacrylic acid, itaconic acid, citraconic acid, maleic acid, fumaric acid and vinylbenzoic acid.

A thermoplastic polymer of a microcapsule suitable for the invention can be obtained by the copolymerization of several of the monomers cited above.

A thermoplastic polymer of a microcapsule suitable for the invention is typically obtained from acrylonitrile, acrylic ester and/or olefins.

In one embodiment of the invention, the microcapsules used in a composition according to the invention comprise a shell based on an acrylonitrile copolymer such as the copolymer acrylonitrile/methacrylonitrile or the copolymer acrylonitrile/methacrylonitrile/hydroxyethyl methacrylate.

In another embodiment of the invention, the microcapsules used in a composition according to the invention comprise a polymeric shell formed from monomers chosen from (meth)acrylic monomers, (meth)acrylonitriles monomers, and mixtures thereof. Preferably, said shell is obtained by the polymerization of monomers chosen from methyl methacrylate, acrylonitrile and mixtures thereof.

Preferably, the thermoplastic polymer constituting the shell of a microcapsule suitable for the invention has a light transmission greater than or equal to 70%, in particular of at least 80% and preferably of at least 88%.

The volatile liquid core of the microcapsules consists of a liquid whose vaporization temperature is low. A so-called “low” vaporization temperature for said liquid is less than or equal to the glass transition temperature of the polymer of the shell.

Said liquid may have a vaporization temperature of from 50° C. to 200° C.

Such a liquid may be a hydrocarbon such as pentane, neopentane, isopentane, cyclopentane, acetylene, hexane, cyclohexane, methylcyclohexane, heptane, cycloheptane, heptene, octane, isooctane, cyclooctane, octene and mixtures thereof.

Among the hydrocarbons, alkanes that are liquid at room temperature, such as pentane, neopentane, isopentane, cyclopentane, hexane, cyclohexane, methylcyclohexane, heptane, cycloheptane, octane, isooctane and cyclooctane are preferred.

Among the other compounds capable of constituting the core of the microcapsules, mention may be made of tetraalkylsilanes such as tetramethylsilane, trimethylethylsilane, trimethylisopropylsilane and trimethyl-n-propylsilane.

The microcapsules which are suitable for the invention may therefore contain a liquid having a low vaporization temperature, in particular chosen from hydrocarbons, and preferably chosen from alkanes.

In particular, the liquid core of a microcapsule suitable for the invention comprises at least one hydrocarbon, preferably chosen from isopentane, pentane, hexane, cyclohexane, methylcyclohexane, heptane, heptene and mixtures thereof, and even more preferably chosen from isopentane and methylcyclohexane.

The microcapsules suitable for the invention may comprise from 3% to 50% by weight of volatile liquid and preferably from 5% to 30% by weight of volatile liquid relative to the total weight of a microcapsule.

The microcapsules suitable for the invention have a dimension, in particular a diameter, of less than or equal to 5 μm, in particular of less than or equal to 1 μm, and preferably of less than or equal to 500 nm.

When the microcapsules are spherical in shape, the dimension discussed in the preceding paragraph corresponds to the diameter of the microcapsules, in particular the average diameter of a set of particles.

Indeed, the smaller the microcapsules, the better the transparency of an adhesive composition comprising them and therefore of a laminated glazing containing that composition. This is observed by a greater light transmission for an adhesive composition comprising microcapsules of smaller dimensions.

Conversely, an adhesive composition comprising microcapsules with a size greater than 5 μm does not exhibit satisfactory transparency for an application in automotive glazing.

An adhesive composition according to the invention may contain from 1% to 10% by weight of microcapsules as described above relative to the total weight of the adhesive composition, in particular from 2% to 8% by weight and preferably from 3% to 7% by weight of said microcapsules.

An adhesive composition according to the invention may also comprise, as expansion means, chemical blowing agents.

The chemical blowing agents are compounds capable of releasing gas by thermal decomposition. These are known and typically used to form polymeric foams.

According to the same principle as that disclosed above, the gas released by these chemical blowing agents makes it possible to weaken the cohesion forces at the PVB/glass interfaces and ensures an easier disassembly of a laminated glazing for the motor vehicle.

The chemical blowing agents which are suitable for the invention have carbon/oxygen (C—O), nitrogen (N—N) and/or nitrogen/sulfur (N—S) bonds capable of breaking when heat is supplied. This breaking leads to the release in gaseous form of carbon dioxide (CO₂) ammonia (NH₃), dinitrogen (N₂), sulphur dioxide (SO₂) and/or water (H₂O).

The chemical blowing agents which are suitable for the invention can be chosen from carbonates, azo compounds, in particular hydrazides such as azodicarbonamide; hydrazine derivatives; nitroso- compounds and/or tetrazoles.

Among the carbonates able to be used as chemical blowing agents according to the invention, mention may be made of sodium bicarbonate, sodium carbonate and zinc carbonate.

Among the azo compounds that can be used as chemical blowing agents according to the invention, mention may be made of azobisisobutyronitrile and hydrazides such as azobicarbonamide and diisopropyl azodicarboxylate.

Among the hydrazine derivatives that can be used as chemical blowing agent according to the invention, mention may be made of semicarbizide; polymeric sulfonic hydrazides such as poly(methacryloylenesulfonylhydrazide); and sulfonylsemicarbazides such as para-toluene-sulfonylsemicarbazide and 4,4′-oxybis(benzenesulfonylsemicarbazide).

Among the nitroso- compounds that can be used as chemical blowing agents according to the invention, mention may be made of dinitrosopentamethylenetetramine.

Among the tetrazoles that can be used as chemical blowing agents according to the invention, mention may be made of 5-phenyltetrazole and 5-aminotetrazole.

In a particular embodiment, the adhesive composition according to the invention comprises a phase consisting essentially of PVB, the at least one expansion means being located alternately at the surface of the phase consisting essentially of PVB or in at least one additional phase comprising PVB.

Thus, the composition according to the invention may take the form of different mono- or multiphase systems.

In a first embodiment, the composition according to the invention consists of a phase comprising PVB and the at least one expansion means.

In a second embodiment, the composition according to the invention comprises a phase consisting essentially of PVB on the surface of which the at least one expansion means is located.

Such a composition may for example be obtained by the deposition of a coating composed of an organic phase, in particular consisting of polymers, preferably PVB and expansion means, at the surface of the phase consisting of PVB.

In a third embodiment, the composition according to the invention consists of a first phase comprising PVB and the at least one expansion means and a second phase consisting of PVB.

In a fourth embodiment, the composition according to the invention consists of a first phase comprising PVB and the at least one expansion means, a second phase consisting of PVB, and a third phase comprising PVB and the at least one expansion means.

A composition according to the third and fourth embodiments may for example be obtained by coextrusion of an adhesive composition according to the invention and of a composition consisting of PVB.

The second, third and fourth embodiments have the advantage of concentrating the at least one expansion means in a zone near the interface, or even at the interface, of the adhesive composition with the support on which it adheres, in particular a sheet of glass. This makes it possible, during disassembly, to better weaken the cohesion forces between the PVB and the support on which it adheres, for example glass. This improvement can be characterized by using a lesser amount of expansion means and/or by reducing the heating time required to obtain disassembly.

The invention also relates to a method for obtaining an adhesive composition according to the invention, comprising a step of mixing the PVB with a plasticizing composition comprising at least one plasticizer and the at least one expansion means.

In a method known to a person skilled in the art to obtain a PVB-based adhesive composition, such as an adhesive composition according to the invention, at least one plasticizer is added so as to modify the elastic properties of the adhesive composition, in particular its flexibility and its processability.

Such plasticizers are also known to the person skilled in the art and are, for example, phthalates, trimellitates, adipates, sebacates, maleates, epoxidized fatty acids, sulfonamides, organophosphates, polyethers or mixtures thereof. For example, triethylene glycol di-2-ethylhexanoate (3G8) can be used as a plasticizer in adhesive compositions suitable for the invention.

The inventors have discovered that at least one expansion means included in an adhesive composition according to the invention could be incorporated therein according to a conventional method for preparing a PVB-based adhesive composition, during the addition of plasticizer.

To this end, the method for preparing an adhesive composition according to the invention may comprise an initial step of mixing at least one plasticizer with the at least one expansion means.

Thus, in the present text, “phase consisting essentially of PVB” refers to a phase not comprising other constituents than those usual for a PVB-based adhesive composition for a PVB-based glass article. In the present text, a phase consisting essentially of PVB is therefore capable of containing at least one plasticizer and at least one additive such as a dye or a UV-ray inhibitor.

In the present text, a phase consisting essentially of PVB therefore comprises less than 1% by weight of expansion means, in particular less than 0.5% by weight and preferably less than 0.1% by weight relative to the total weight of the phase. A phase consisting essentially of PVB is preferably devoid of expansion means.

The invention also relates to an automotive laminated glazing comprising at least two glass sheets and, as lamination interlayer, a layer of adhesive composition according to the invention.

Conventionally, the main faces of a laminated glazing for a motor vehicle are numbered from 1 to 4:
face F1 is the external (exterior) face of the exterior glass that is preferably tinted;
face F2 is the internal face (lamination interlayer side) of the exterior glass;
the lamination interlayer, consisting here of the adhesive composition according to the invention;
face F3 is the internal face (lamination interlayer side) of the preferably colorless interior glass, often of a thickness less than or equal to that of the exterior glass;
face F4 is the internal face (passenger compartment side) of the interior glass.

In a particular embodiment, the automotive laminated glazing according to the invention comprises a PVB layer and at least one layer of adhesive composition according to the invention, said layer(s) of adhesive composition being in contact with at least one glass sheet.

Such a glazing can be obtained using an adhesive composition as described in the third and fourth embodiments described above.

In a particular embodiment, in the automotive laminated glazing according to the invention, the expansion means are located in contact with at least one glass sheet.

Such a glazing can be obtained using an adhesive composition as described in the second embodiment described above.

In these embodiments, the layer of adhesive composition and/or the expansion means is/are in contact with the face F2 and/or the face F3 of the laminated glazing according to the invention.

Thus, the cohesion forces at the interfaces of the lamination interlayer and of the glass can particularly be weakened on demand, while minimizing the amount of expansion means present in the lamination interlayer.

Laminated glazings according to the invention corresponding to the particular embodiments described above are therefore particularly easily disassembled.

Furthermore, the use of a small amount of expansion means also makes it possible to minimize their influence on the optical properties of the glazings according to the invention.

The laminated glazing according to the invention may have a haze of at most 2%, in particular of at most 1.5%, and preferably of less than or equal to 1%.

In the automotive laminated glazing according to the invention, the adhesive composition may have a thickness of from 100 μm to 2100 μm, in particular from 300 μm to 1100 μm and preferably from 650 μm to 850 μm.

In the automotive laminated glazing according to the invention, the glass sheets may have a thickness of from 0.1 mm to 6 mm, in particular from 0.3 mm to 5 mm and preferably from 0.7 mm to 3 mm.

The glass sheets suitable for an automotive laminated glazing according to the invention may consist of mineral glass, in particular chosen from soda-lime-silica glass, aluminosilicate glass and borosilicate glass.

Preferably, the glass sheets which are suitable for an automotive laminated glazing according to the invention are chosen from calcium-lime-silica glasses.

The glass sheets which are suitable for an automotive laminated glazing according to the invention are preferably colorless, and have a light transmission value of at least 85%, or even 90%, preferably within the meaning of the standard EN 410: 1998.

The glass sheets which are suitable for an automotive laminated glazing according to the invention may be clear glasses (light transmission LT higher than or equal to 90% for a thickness of 4 mm), for example standard soda-lime composition glasses such as Planilux® from Saint-Gobain Glass, or an extra-clear glass (light transmission higher than or equal to 91.5% for a thickness of 4 mm), for example a soda-lime-silica glass with less than 0.05% by weight Fe III or Fe₂O₃ such as the glass Diamant® from Saint-Gobain Glass, or the glass Optiwhite® from Pilkington or the glass B270® from Schott, or another composition described in document WO04/025334. The glass sheets which are suitable for an automotive laminated glazing according to the invention may also consist of Planiclear® Glass from the company Saint-Gobain Glass.

The glass sheets suitable for an automotive laminated glazing according to the invention may also be bent and/or tempered glasses, in particular thermally, preferably at a temperature greater than or equal to 450° C., or better still greater than or equal to 600° C.

In one embodiment of the invention, the automotive laminated glazing according to the invention is a windshield or a roof, in particular a windshield.

When the automotive laminated glazing according to the invention is a roof, it must meet current motor-vehicle specifications in particular with respect to light transmittance L_{T} and/or energy transmittance T_{E} and/or energy reflectance R_{E} and/or even with respect to total solar transmittance TST.

For an automotive roof, they are often tinted, non-zero light transmission L_{T} is preferred, and even at least 0.5% or at least 2% and at most 40% and even at most 20%.

For an automobile roof, a haze of less than or equal to 2% is preferred.

For an automobile roof, one or more of the following criteria are preferred:
T_{E} of no more than 10% and preferably comprised from 4% to 6%,
R_{E}, in particular on the side of the external face, toward the outside of the vehicle, of no more than 10%, and preferably of from 4% to 5%,
TST less than 30%, in particular less than 26% and preferably between 20% and 23%.

When the automotive laminated glazing according to the invention is a windshield, the light transmittance may be greater than or equal to 70%, in particular greater than or equal to 75% and preferably at least 80%.

When the automotive laminated glazing according to the invention is a windshield, the following configuration can be provided:
face F1 is the external (exterior) face of the exterior glass that is preferably colorless and barely tinted;
face F2 is the internal face (lamination interlayer side) of the exterior glass;
the lamination interlayer is the adhesive composition according to the invention, if necessary tinted in order to compensate for the low tint of the exterior glass;
face F3 is the internal face (lamination interlayer side) of the interior glass, preferably colorless;
face F4 is the internal face (passenger compartment side) of the interior glass.

A laminated glazing according to the invention is easily disassembled by heating, which provides heat to the adhesive composition comprising an expansion means, under the effect of which said expansion means increases the total volume of the adhesive composition and weakens the cohesion forces at the interfaces between the adhesive composition and the glass sheets.

This ease of disassembly is particularly advantageous for the recycling of automotive glazing.

The invention therefore also relates to a method for disassembling an automotive laminated glazing according to the invention, comprising a step of heating the automotive laminated glazing at a temperature comprised between 110° C. and 260° C., in particular from 120° C. to 250° C. and preferably from 180° C. to 220° C. for a period of between 0.5 and 10 minutes, in particular from 1 to 5 minutes and preferably from 1.5 to 3 minutes.

In a particular embodiment, the heating step is carried out by means of a furnace, a hot air gun, infrared rays, microwaves or induction.

The disassembly method according to the invention has the advantage of being easily implemented and of making it possible to recover over a short time the non-polluted constituent elements of the automotive laminated glazing (adhesive composition and glass sheets), that is to say those in which less than 5% by weight of the other components of the automotive glazing remain.

The invention finally relates to a method for obtaining an automotive laminated glazing according to the invention, comprising a step of applying an adhesive composition according to the invention on a face of a glass sheet, then a step of placing a second glass sheet on the adhesive composition.

1. An adhesive composition for a glass article comprising polyvinyl butyral (PVB), and at least one expansion means.

2. The adhesive composition according to claim 1, wherein the expansion means is selected from microcapsules and/or chemical blowing agents.

3. The adhesive composition according to claim 2, wherein the microcapsules represent from 1 to 10% by weight relative to a total weight of the composition.

4. The adhesive composition according to claim 2, wherein the microcapsules comprise a polymer shell formed from monomers selected from the (meth)acrylic monomers, (meth)acrylonitriles monomers and mixtures thereof.

5. The adhesive composition according to claim 2, wherein the microcapsules comprise a liquid having a low vaporization temperature.

6. The adhesive composition according to claim 2, wherein the microcapsules have a dimension of less than or equal to 5 μm.

7. The adhesive composition according to claim 2, wherein the chemical blowing agents are chosen from carbonates, azo compounds, nitroso- and/or tetrazoles compounds.

8. The adhesive composition according to claim 1, comprising a phase consisting essentially of PVB, the at least one expansion means being located alternately at a surface of the phase consisting essentially of PVB or in at least one additional phase comprising PVB.

9. The method for obtaining an adhesive composition according to claim 1, comprising mixing the PVB with a plasticizing composition comprising at least one plasticizer and the at least one expansion means.

10. An automotive laminated glazing comprising at least two glass sheets, and, as lamination interlayer, an adhesive composition layer according to claim 1.

11. The automotive laminated glazing according to claim 10, wherein the lamination interlayer comprises a PVB layer and the at least one adhesive composition layer, said at least one adhesive composition layer being in contact with at least one of the at least two glass sheets.

12. The automotive laminated glazing according to claim 10, wherein the expansion means are located in contact with at least one of the at least two glass sheets.

13. The automotive laminated glazing according to claim 10, wherein the layer of adhesive composition has a thickness of from 100 μm to 2100 μm.

14. The automotive laminated glazing according to claim 10, said automotive laminated glazing being a windshield or a roof.

15. The automotive laminated glazing according to claim 10, said automotive laminated glazing being a windshield and having a light transmission greater than or equal to 70%.

16. The automotive laminated glazing according to claim 10, said automotive laminated glazing having a haze of at most 2%.

17. A method for obtaining an automotive laminated glazing as defined in claim 10, comprising applying the adhesive composition to a face of a first glass sheet of the at least two glass sheets, then placing a second glass sheet of the at least two glass sheets on the adhesive composition.

18. A method for disassembling the automotive laminated glazing as defined in claim 10, comprising heating the automotive laminated glazing at a temperature comprised from 110° C. to 260° C. for a period of between 0.5 and 10 minutes.

19. The disassembly method according to claim 18, wherein the heating is carried out by a furnace, a hot air gun, infrared rays, microwaves or induction.

20. The adhesive composition according to claim 3, wherein the microcapsules represent from 2 to 8% by weight relative to the total weight of the composition.
